(19) United States
(12) Patent Application Publication
(10) Pub. No.: US 2012/0197751 A1
(43) Pub. Date: Aug. 2, 2012

(54) PRODUCT RECOMMENDATIONS AND WEIGHTING OPTIMIZATION SYSTEMS

(75) Inventors: Geoffrey C. Zatkin, Encinitas, CA (US); Gregory T. Short, Carlsbad, CA (US); Theodore Spence, Oceanside, CA (US); Jesse Divnich, Carlsbad, CA (US)

(73) Assignee: ELECTRONIC ENTERTAINMENT DESIGN AND RESEARCH, Carlsbad, CA (US)

(21) Appl. No.: 13/357,450

(22) Filed: Jan. 24, 2012

Related U.S. Application Data
(60) Provisional application No. 61/436,836, filed on Jan. 27, 2011.

(51) Int. Cl. G06Q 30/00

(52) U.S. Cl. 705/26.7

(57) ABSTRACT

A product recommendation ecosystem is presented. A rules engine seeks to discover one or more relationships among cross-brand product categories based on non-transaction correlations. The rules engine constructs a generic rules-set based on the universal relationships. The rules-set is sent to a recommendation engine, possibly a subscriber to the services offered by the rules engine, and the rules-set configure the recommendation engine to generate one or more cross-brand product recommendations. The recommendation engine customizes the rules-set according to location-specific information possibly comprising consumer parameters, product parameters, vendor parameters, or other local information.

This application claims the benefit of priority to U.S. provisional application having Ser. No. 61/436,836, filed on Jan. 27, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is product research technologies.

### BACKGROUND

Retailers, vendors, or other merchants continue to develop recommendation systems to place recommended products in front of consumers. For example, NetFlix™ offered a $1,000,000 prize for an algorithm that would “ . . . substantially improve the accuracy of predictions about how much someone is going to enjoy a movie based on their movie preferences” (see URL www.netflixprize.com). Interestingly, the winning algorithm (see www.the-ensemble.com) requires survey information from a consumer or other consumer transactions.

Other known recommendations systems also utilize consumer-related transactions to generate recommendations. For example, U.S. Pat. No. 7,720,720 to Sharma et al. titled “System and Method for Generating Effective Recommendations”, filed Aug. 4, 2004, describes a system capable of generating recommendations relating to an on-line shopping experience. The recommendations are based on transaction history.

U.S. Pat. No. 7,966,219 to Singh et al. titled “System and Method for Integrated Recommendations”, filed Sep. 24, 2004, describes a recommendation appliance that can track transaction activities and can introduce recommendation messages into web pages without requiring modification of code on a web server.

U.S. patent application publication 2002/0065721 to Lema et al. titled “System and Method for Recommending a Wireless Product to a User” filed Oct. 5, 2001, discusses that an evaluation engine and a logic engine can work together to generated product recommendations based on user surveys.

U.S. patent application publication 2004/0059626 to Smallwood titled “Bayesian Product Recommendation Engine”, filed Sep. 23, 2002, discloses generating a recommendation for a product type based on at least one user preference, which still requires a consumer to product transaction.

U.S. patent application 2006/0179045 to Grinsfelder et al. titled “Retail Store Recommendation Engine”, filed Jan. 4, 2006, discloses a kiosk that filters a user search results in a recommended subset as determined by retailer selected criteria.

U.S. patent application 2007/0094066 to Kumar et al. titled “Method an Apparatus for Recommendation Engine Using Pair-Wise Co-Occurrence Consistency”, filed Jan. 6, 2006, describes discovering patterns in relationships between products and consumer evidenced by purchasing behavior.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The above referenced art all seek some form of feedback based on consumer-product interactions, or to a lesser extent vendor-product interactions. The above disclosed approaches require some form of consumer-oriented transaction take place to even begin to establish a relationship between the consumer and product in order to make a recommendation. Although useful in providing recommendations based on user behavior or input, such approaches fail to allow consumers to explore beyond their own boundaries and possibly find new products they would not ordinarily find. Further, the referenced art fail to appreciate that relationships can be established among products, even across widely disparate brands. As discussed herein in the Applicant's work, product-to-product relationships can be discovered through non-transaction correlations, which can allow consumers to discover new and interesting products.

Thus, there is still a need for systems non-transaction based recommendation systems.

### SUMMARY OF THE INVENTION

The inventive subject matter provides apparatus, systems and methods in which one can obtain product recommendations even across disparate brands via discovering universal relationships. One embodiment of the inventive subject matter includes recommendation systems having a product database and a rules engine. The product database can store product information including attributes relating to or describing various products across multiple brand classifications (e.g., product type, genre, media, vendor, franchise, etc.). The rules engine communicatively couples with the product database and is configured to create one or more rules-sets through an analysis of the product information, where the rules-sets comprises instructions that configured a recommendation engine to provide product recommendations. The rules engine generates rules-sets by discovering universal relationships (e.g., relationships, common attributes, etc) among products across brand classifications based on the product attributes and non-transaction correlations, then using the universal relationships and product information from a brand class to create rules-sets. A rules-set can be encoded in a serialized format (e.g., XML, RuleML, etc.) that can be sent to a remote recommendation engine. The rules-sets can include generic rules or instructions that are fleshed out by the recommendation engine. For example, a rules-set can operate as a function of non-specific variables; product variables or consumer variables for example. The recommendation engine can assign values to the variables based on local information and then generates queries for recommended products based on the fleshed out rules-set.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a recommendation system in a recommendation ecosystem.

FIG. 2 is a schematic of products belonging to different brand classes.

FIG. 3 is a schematic of products from different brand classes having correlated attributes through which universal relationships can be discovered.

FIG. 4 is a schematic of universal relationships and products giving rise to a cross-brand rules-set.

FIG. 5 is a schematic of a recommendation engine.

FIG. 6 is a schematic of a method for making cross-brand recommendations.

### DETAILED DESCRIPTION

It should be noted that while the following description is drawn to a computer/server based recommendation and rules engines, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including using a rules-engine to generate one or more instructions, or command sets that configure remote devices including recommendation engines. The same rules-set can be sent to multiple recommendation engines, which customize the rules-set based on local information. The recommendation engine constructs recommended product queries from the customized rules-set.

The following discussion provides many example embodiments of the inventive subject matter. Although each embodiment represents a single combination of inventive elements, the inventive subject matter is considered to include all possible inventive combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, “coupled with” within the context of network connections includes the concept of being communicatively coupled in a manner where communicatively coupled devices can exchange information with each others over the network.

The inventive subject matter is considered to include a recommendation ecosystem capable of identifying possible recommendations to consumers for products in a first market based on products in a completely different market. The engine can include a product database storing product information across multiple brand classifications. Example brand classifications include genre, product type or category, media type, supply chains, celebrity, vendor, publisher, franchise, or other categories. The product information can include product attributes, preferably stored according to a common universal namespace.

The recommendation system can further include a rules engine configured to generate one or more rules-sets that configure a recommendation engine to generate recommendations relating to products of possible interest even when the products span across wide marketing gaps. The rules engine can analyze the product information to discover universal relationships (e.g., relationships among attributes in the namespace) across brand classifications based on non-transaction correlations among products. The relationships can be established via one or more algorithms, possibly based on AI techniques: neural networks, generic algorithms, multi-variate analysis, inference reasoning, Bayesian analysis, or other techniques.

Once the universal relationships are obtained or otherwise discovered, the rules engine can construct a cross-brand rules-set that configures a target recommendation engine. Recommendation engines are computing devices that are configured to accept the rules-set and run the rules to generate recommendations. Example recommendation engines can include kiosks in stores, web sites, gaming platforms, or other computing devices. A kiosk in WalMart® might generate different recommendations than a kiosk in Target® even though the same consumer operates both kiosks and the rules-sets for each kiosk is generated from the same data could be identical. For example, WalMart might wish to weight recommendations based on available inventory while Target might wish to weight recommendations to promote a future sale item.

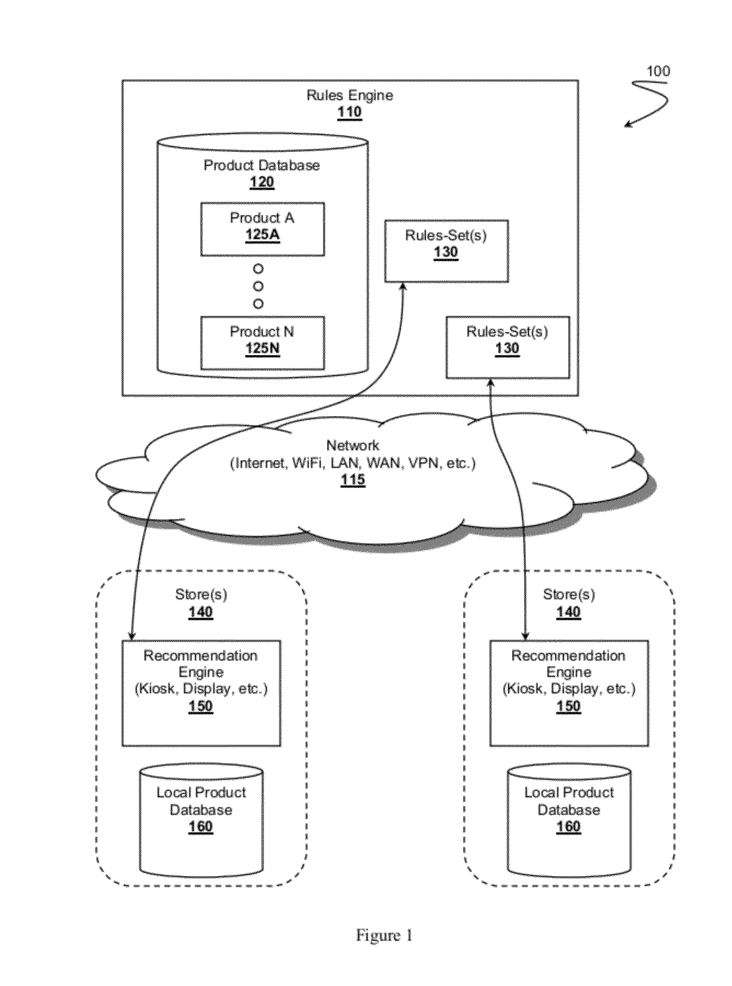

In FIG. 1, the recommendation ecosystem includes recommendation system 100 that creates one or more rules-sets 130 that configure remote recommendation engines 150, possibly located in various stores 140, to generated product recommendations across multiple brand classification. Rules-sets 130 can be transmitted to recommendation engines over network 115 using known standard protocols (e.g., HTTP, SSL, SSH, FTP, SMS, SMTP, etc.).

In more preferred embodiments, rules engine 110 operates as part of a for-fee service to which one or more of stores 140 (e.g., retailers, chains, vendors, etc.) subscribe. Rules engine 110 represents an analysis system capable of analyzing product information stored in product database 120. The product information can be stored according to various schema without departing from the inventive nature of the subject matter. For example, the product information could be bound to products 125A through 125N, collectively referred to as products 125, where each of products 125 can be considered a separate or distinct manageable object. The product objects can include one or more product attributes describing the product represented by the products 125.

Products 125 carry a great deal of information within their product attributes covering a very broad spectrum of information. Each product can be classified according to one or more brand classifications where the brand classifications can also cover a broad spectrum of concepts. Brand classifications can be aligned with traditional brands, trademarks for example, or can extend beyond traditional branding over the horizon toward alternative brand classifications. Example brand classifications can include celebrity, franchise, genre, product type or category, media type, supply chains, vendor, publisher, or other categories. The brand classifications can be user-defined or can be derived through comparing unclassified products 125 against classified products.

Products 125A through 125N can be indexed through various indexing systems. In some embodiments, products 125 can be indexed by their product attributes, possibly according to a hierarchical scheme. Further, products 125 can be multiply indexed to allow for a product to fall into different levels of hierarchy and provide for easy access depending on which attributes are used to search for products in product database 120. Thus, products 125 can be indexed or identified by any number of attributes. Products 125 could be stored as N-tuples of information where each member item in the N-tuple represents a possible attribute value. Alternatively, products 125 could merely include attributes, and corresponding values, bound to the products. For example, product 125A might have 1,500 attributes and values bound to it while product 125N might have 5,230 attributes and values.

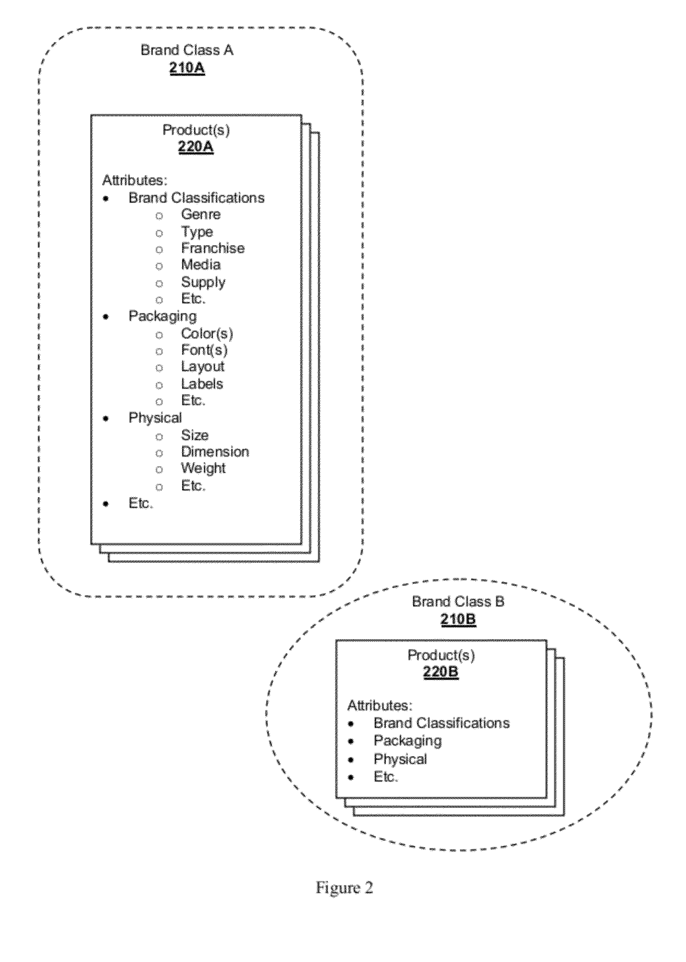

One especially preferred attribute includes brand classifications. Products 125A can belong to more than one brand classification. For example, a video game could belong to the follow brand classifications: <publisher::Traveler's Tales Games Publishing, LLC>, <genre::puzzle>, <franchise::Batman>, <franchise::LEGO>. Additionally, a bubble bath or shampoo might belong to the following brand classifications: <vendon:Avon>, <franchise::Batman>, <product type::soap>, <product type::soap.shampoo>. As the reader can see, products 125 can fall within one or more brand classification. Further, products 125 can also be indexed or retrieved according to their brand classifications. Although the brand classifications are presented as attribute—value pairs, other constructions are also possible including linked lists, table pointers, N-tuples, or other static or dynamic data structures. Brand classifications are discussed further with respect to FIG. 2.

Rules engine 110 analyzes the product information available about products 125 using non-transaction correlations as one possible starting point. When a non-transaction correlation is found, automatically or user defined, rules engine 110 compares attributes of products 125 having the correlation to discover if a relationship might exist between the products, at least to within some level of certainty. Preferably, the discovered universal relationships represent relationships across brand classifications. For example, a video game might have a relationship with a celebrity where the video game and celebrity have an association with a color (e.g., video game packaging color, celebrity dress color) based on a non-transaction correlation where both the video game and celebrity were referenced in a news story. If a universal relationship is discovered, rules engine 110 creates cross-brand rules-set 130 capable of configuring recommendation engines 150 to generate cross-brand recommendations.

One should appreciate that rules engine 110 does not necessarily generate recommendations, unless it is also one of recommendation engines 150. Rather, the rules-set 130 can be considered generic with respect to stores 140 or consumers. A single common rules-set 130 can be sent to different retailers where each of recommendation engines 150 customize the rules-set 130 to fit the locale based on information in their own local product databases 160.

Counter to previous approaches, providing one or more generic rules-set 130 allows for greater local customization at stores 140. Local customization aids in increasing benefits to the consumer, retailer, vendor, or other site-specific entity. Although the inventive subject matter is based on non-transaction correlation, it is contemplated that transaction correlations could also be leveraged to augment discovery of universal relationships. Non-transaction correlations are considered advantageous because it provides an “out-of-the-box” discovery mechanism for the consumer.

Recommendation engines 150 can take on many different forms beyond kiosks. Alternative example embodiments of recommendation engines 150 include a television, a cell phone, a set top box, a game console, a web server, an electronic display, or other form of computing device having access to site-specific information. Although local product databases 160 are illustrated as being local to stores 140, one should appreciate the site-specific information in such a database could be distal from stores 140, yet accessible over network 115.

FIG. 2 provides a further detailed illustration of brand classifications. Products 220A or 220B can fall within one or more brand classifications. In the example shown, brand class 210A includes a number of products 220A, each having a common brand classification attribute, perhaps genre. Brand class 210B includes a different set of products 220B, each having another, different brand classification attribute than the common attribute from brand class 210A. Products 220A and 220B can include many different types of products having the common attributes. For example products 220A might have the common brand classification of a horror genre and can include video games, books, toys, foods, party theme services, or other types of products. Further, products 220A and 220B can include goods or services.

As discussed previously, brand classifications can cover a wide spectrum of concepts. In some embodiments the brand classification scheme can be organized according to one or more hierarchical structures. One structure could be based on vendor-related brand classifications: name, product types, distribution channels, trademarks, etc. An overlapping (e.g., orthogonal) structure could be based on consumer-related brand classifications: target demographic, gender, etc. One possible structure for brand classifications could include using the United States Patent and Trademark Office trademark classification scheme.

Product attributes within products 220A and 220B can be assigned values based on a common normalized namespace so that one product's attributes in brand class 210A can be compared to product attributes of a product in a completely different brand class 210B. Further, product attributes can be bound to a brand classification. For example, a vendor-related brand classification might have attributes that only pertain to vendor related information.

Brand classifications can be considered silos of products, preferably where there are no overlaps between products 220A and 220B. If there are overlaps, possibly where one of products 220A is also in brand class 210B, then the overlapping product can be removed from further analysis. Alternatively, the overlapping product can remain in the analysis but assigned a weighting factor representing how strongly aligned the product is with the brand classification. For example, an overlapping product might have an affinity of 0.95 with brand class 210A and only an affinity of 0.05 with brand class 210B, where affinity is a derived, possibly normalized, value based on similarity with other products in the brand classification.

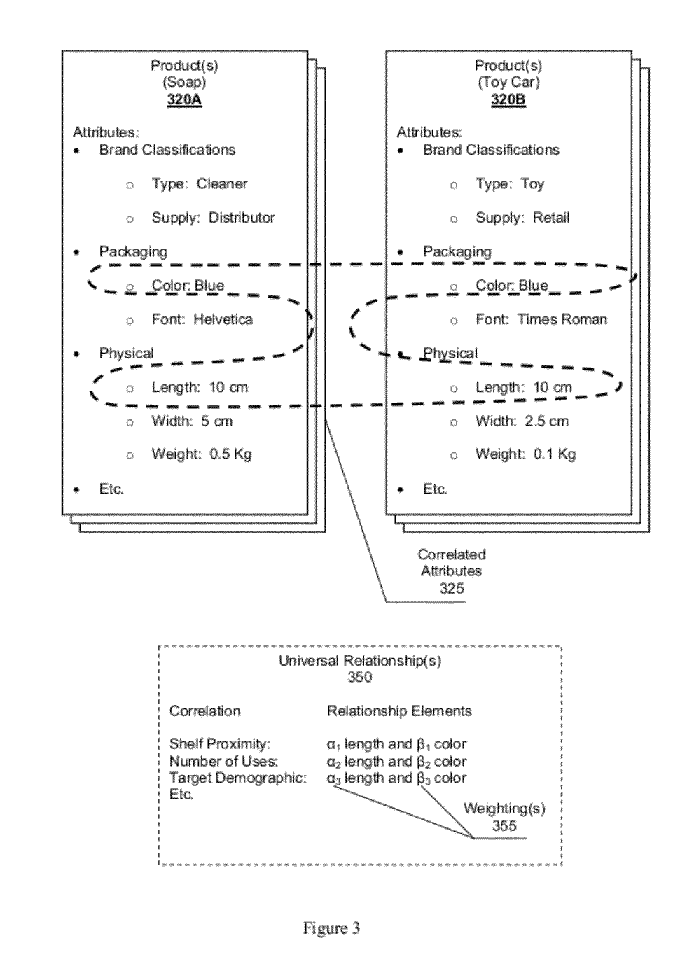

In FIG. 3 products 320A and 320B are from different brand classification, soap and toy car respectively. Products 320A and 320B have been found to be associated with each other via one or more non-transaction correlations. Although only one product is presented for each brand classification, one should keep in mind that any number of products (e.g., goods, services, etc.) could be related to each other via the non-transaction correlations. The non-transaction correlations are considered to include product-product interactions. Example non-transaction correlations could include physical or logical proximity to each other in a product inventory (e.g., shelf, stocking, on-line listing, etc.), shipped by the same distributor even though from different vendors or manufacturers, referenced on the same web page, or other correlations. As referenced earlier, the non-transaction correlations could be user defined or automatically derived.

Non-transaction correlations can also be based on reviews. When a review, especially with a quantified rating (e.g., number of thumbs, number of starts, value between 1 and 10, etc.), has more than one product discussed, then the non-transaction correlation can be derived based on the review information.

The non-transaction correlations can be user defined or auto generated, through exploration of product attributes. For example, a user could define a non-transaction correlation based on a search of all products having a specific attribute, or combination of attributes. The search can be in the form of a query, which can be considered to represent the non-transaction correlation. The query might request all products of a particularly set of types (e.g., toys, soaps) that are distributed by ground transport. The system then obtains search results of all products satisfying the query. The rules engine can then group the results into brand classifications.

It should be appreciated there can be myriad of non-transaction correlations. One aspect of the inventive subject matter is considered to include a rules engine reviewing many different defined non-transaction correlations to determine a strength of the correlation. In some embodiments, non-transaction correlations can be strengthen by or validated by traditional transaction correlations (e.g., consumer-product interactions, purchase, survey results, preferences, etc.). Once found, the correlation can be compared to transaction correlations to determine strength in the market if desired. However, such an approach is not required.

Regardless of the nature of the non-transaction correlation, a rules engine conducts an analysis of products 320A with respect to products 320B to discover if there is a relationship between the products. Once products 320A and 320B have been classified based on their brand classifications, the products attributes can be analyzed to determine if there exists other possible relationships among the product beyond a query requirement. If the non-transaction correlation requires a common distribution channel, such attributes can be removed from the analysis.

These relationships can be constructed based on common attributes within the products or brand classifications. In the example shown, correlated attributes 325 are found. One should appreciate that the analysis does not necessarily have to establish that common attributes are present. Rather, the rules engine seeks to discover that a relationship exists among the products based on their attributes. For example, the products in soap might all have blue packaging while toy cars might all of a specific value for an attribute (e.g., font is Times Roman). The system can discover or infer that the products of the two brands have a relation based on the blue packaging and times roman font. In the example shown, the rules engine discovers that one or more of correlated attributes 325 exist. The example of correlated attributes 325 is a simple example for illustrative purposes only. The relationship between products 320A and 320B can be quite complex or can depend on multiple product attributes.

The Applicants own work can be leveraged to determine if correlations exist based on an analysis as discussed in co-owned U.S. Pat. No. 7,580,853 to Short et al. titled “Methods of Providing a Marketing Guidance Report for a Proposed Electronic Game”, filed Apr. 13, 2007. Although focused on the video game market, the disclosed techniques can be applied to other markets beyond video games.

The rules engine attempts to discover one or more relationships among products 320A and 320B across their brand classifications. In the example, universal relationships 350 represents relationships discovered for various types of non-transaction correlations. Universal relationships 350 are considered universal because they are based on information available within the product space (e.g., attributes, classifications, correlations, product-product interactions, etc.) rather than narrowly limited to a single specific type of correlation.

Universal relationships 350 are illustrated in a simplified form, but can represent arbitrarily complex set of relationships. In the example, each non-transaction correlation has different weighting factors 355 for each of correlated attributes 325, assuming each of the correlations has a relationship associated with the same attributes. The weighting factors 355 are considered advantageous when determine strength or certainty associated universal relationships 350 related to the correlations.

Relationships can be single-valued or multi-valued, or can include various relational operators. For example, products in one brand classifications have attribute A while products in the other classification have an attribute considered to be NOT(B), where NOT( ) is a logical operator. As another example, two attributes having numerical values could form a linear relationship: ax+by=c, where the x and y values are attribute values, and a, b, and c might be product or consumer variables to be assigned values by a recommendation engine.

One should appreciate that the weighting factors 355 are discovered by the rules engine as it conducts various analysis on the product data. When a weighting is discovered or found to be at least somewhat statistically relevant, possibly validated, the rules engine can further generated an error associated with the weighting value. The errors can be used when generating recommendations by requiring recommended products to fall with in an error spread around a weighting value. For example, the weighting value and error can represent a probability spread indicating a probability for selecting a product; can represent a measure of an attribute, or other salient quantities. A measure of an attribute might represent the measure of product packaging in a certain color; 50% blue for example. When selecting a recommended product, the recommendation engine would seek products having packaging that fall within the range; 50% blue plus or minus 10% for example.

Universal relationships 350 include cloud cluster, trends, inverse relationships (e.g., opposite attributes, lacking attributes, etc.), or other types of relationships. Cloud clusters can include plotting product attributes in two or more dimensions and discovering there is a cluster around attribute values. Such cloud clusters can be rendered on a display or a chart for human analysis or review. Cloud clusters can also include one or more contours possibly representing density variable around the cloud. Trends represent a change of a relationship with time. To continue with cloud clusters as an example, a cloud cluster might change shape or position in a plotted space as time varies.

Universal relationships 350, as mentioned, can include temporal aspects where a discovered relationship changes with time. Based on a dynamic trend analysis of the changes, the rules engine can make predications regarding what a relationship might be at a future date, or what rules should be applied to a recommendation engine at a future data. One should appreciate the contemplated trends are relationship trends rather than product trends. Thus, the rules engine can make perditions on how a universal relationship 350 might change with time.

Universal relationships 350 are presented as if they are relationships between two brand classifications: soap and toys. In more preferred embodiments, universal relationships 350 can be associated with much different brand classification, where universal relationships 350 take on a more universal nature spanning across many different brand classifications.

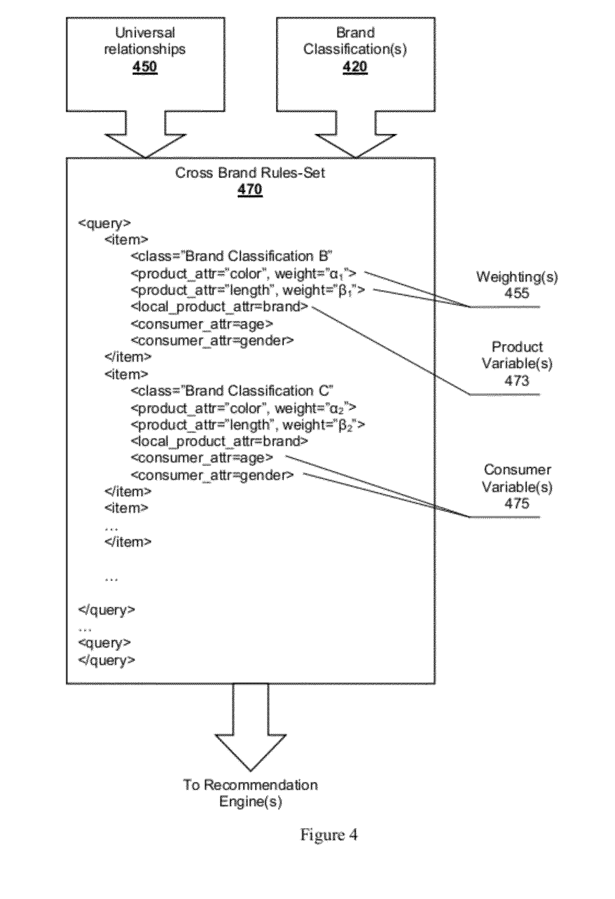

FIG. 4 provides an overview of generating rules-set 470 based on discovered universal relationships 450. One should keep in mind that information from brand classification 420 can include information from multiple brand classifications. The rules engine combines the universal relationships 450 with brand classification 420 to create rules-set 470. One should note that no consumer transaction information is required to generate rules-set 470, although the system could incorporate consumer transaction information if desired.

One should appreciate that consumer transaction information can be considered a hit or miss proposition. The consumer transaction information might aid in determining a pattern of behavior for an individual consumer, but such behavior patterns do not necessarily translate from one brand classification to another. Further, when an individual alters their behavior, as in buying a birthday gift which is out of the ordinary, then the new information can skew a resulting analysis. Although not required, consumer transaction information can be incorporated in the analysis and in generation of rules-set 470 but should be properly weighted to result in a more objective (i.e., non-consumer) perspective.

Rules-set 470 represents a simplified view of a possible cross-brand rules-set. The rules engine generates rules-set 470 preferably through constructing a serialized file having instructions targeting a recommendation engine. As shown, the instructions can be put into an XML based structure, although any file format in principle could be used. Rules-set 470 can include one or more sub-sets of instructions outlining how a recommendation engine should create a product query for recommended products based on brand classifications. Note the instructions can be generic with respect to the recommendation engine, the brand classification, the consumer, or the local product information.

Rules-set 470 includes weightings 455 that were discovered by the rules engine and are aligned with different query generation instructions as discussed previously. In some embodiments, the weightings 455 represent a preferred value of parameter for a cross-brand product. For example, α₁ might be a requirement that the target cross-brand product has packaging with a specific amount of a color. When the recommendation engine constructs a query based on α₁, the query to the local database attempts to find local products having matching packaging to within the limits bounded by α₁. One should note α₁ can be multi-valued, possibly having a main value, a spread or error, or other values.

Rules-set 470 can also include many different types of variables to be assigned values by the recommendation engine based on locally available information. In the example shown, rules-set 470 includes product variables 473 that represent information about products. Note the variables; brand for example, is a generic variable where “brand” does not necessarily equate to a brand classification, but can simply be a traditional brand of product; Procter & Gamble® or trademark for example. When the rules-sets are transmitted to the recommendation engine, the recommendation engine will assign values to product variables 473 according to locally available information. For example, one retail client might distribute a specific brand of shampoo. The recommendation engine at the retail client's location will include the specific information into the variable. While the second retail client's location would likely sell a different brand. Additional variables can include consumer variables 475 reflecting information about a specific consumer; age and gender for example. Other types of variables are also contemplated including retailer variables, distribution channel variables, store location variables, vendor variables, or other variables.

In addition to query structure, rules-set 470 can include other instructions as well (not shown). Additional instructions can include display requirements outlining how or where to position recommended products relative to each other in the display or according to fee schedules. For example, when a specific brand of product is recommended, the manufacturer of the brand can pay for greater prominence of their products in a display.

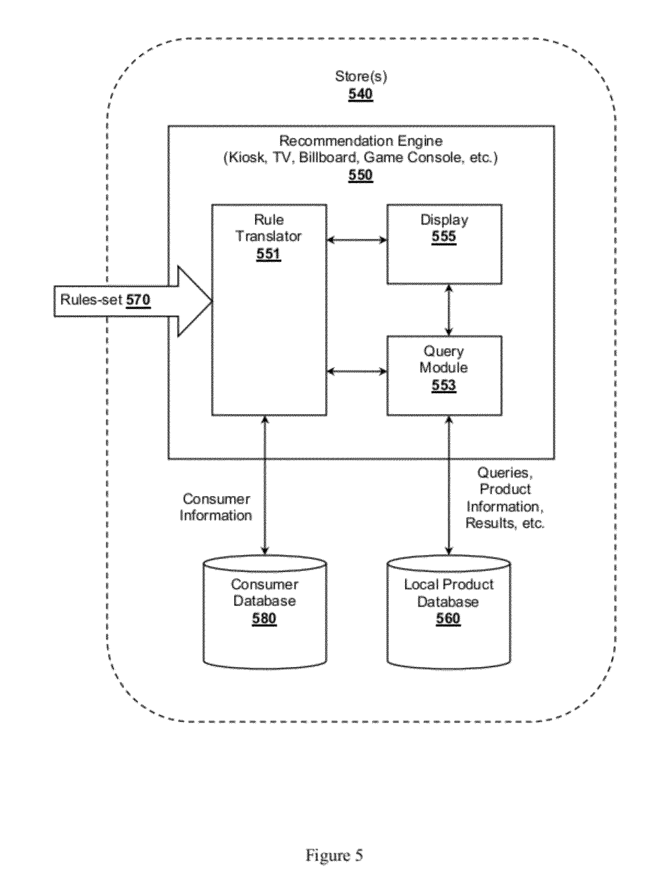

In FIG. 5, rules-set 570 is transmitted to recommendation engine 550 possibly located within a remote store 540. Store 540 could represent a brick and mortar store, an on-line retailer, or other subscriber to the disclosed service. Recommendation engine 550 represents a suitably configured computing device that interprets rules-set 570 and creates one or more locally customized queries for recommended products from rules-set 570. Example devices capable of operating as recommendation engine 550 include an interactive kiosk, an electronic billboard, a television, a set top box (e.g., DVR, cable box, etc.), a game console (e.g., PS3®, Wii®, XBox®, etc.), or other device.

Rules-set 570 is received or otherwise obtained by recommendation engine 550 over a network, preferably the Internet. Recommendation engine 550 translates the rules-sets via rule translator 551. Rule translator 551 interprets the serialized instructions and uses information about the locale of recommendation engine 550 to flesh out the rules-set 570 to create actual queries for recommended products.

Consider an example where recommendation engine 550 comprises kiosk at store 540. Periodically, possibly nightly, rules-set 570 can be sent to recommendation engine 550. When a user interacts with the kiosk, recommendation engine 550 can obtain local information possibly from consumer database 580 or local product database 560. Although consumer database 580 and local product database 560 are illustrated as within store 540, it is also contemplated that the databases could be remote from store 540 and still store local information. The local information is used to assigned values to consumer variables, product variables, or other types of variables within rules-set 570. Rule translator 551 converts rules-set 570, possibly in real time as the user interacts with the kiosk, into one or more queries that can be submitted from query module 553 to local product database 560. Perhaps the user requests a location of a specific product. Based on the consumer information related to the user and product information the rule translator 551 constructs a query requesting cross-brand products related to the initial request from the user.

Once a query is constructed, query module 553 can package the query according the desired schema or indexing system of local product database. Query module 553 submits the query to local product database 560 and receives a set of possible recommended products satisfying the query. Query module 553 can then present recommended products for presentation via an output device, display 555 for example. Recommendation engine 550 configures display 555 to present at least a subset of the returned recommended products according to the instructions of rules-set 570.

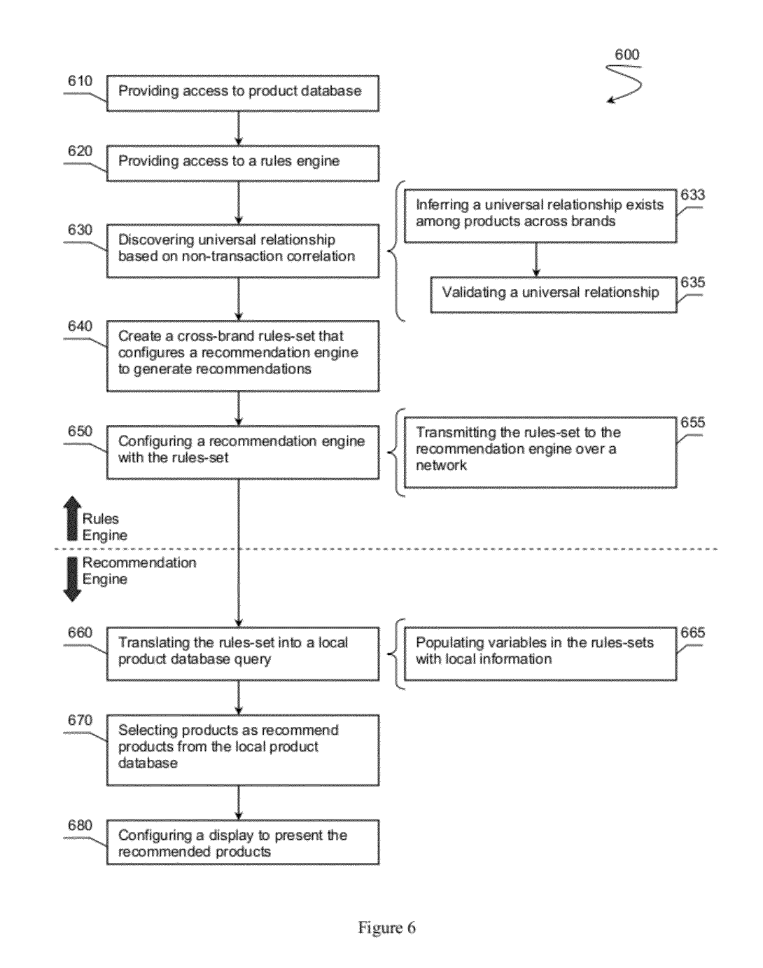

FIG. 6 presents a possible embodiment of a method that generates one or more recommendations. The steps of the method can be broken down into two sets as illustrated where steps 610 through 650 can relate to a rules engine. Steps 660 through 680 relate to a recommendation engine communicatively coupled with the rules engine over a network. Although the two sets of steps are separated from each other, it is contemplated that either engine can take on the other's roles or responsibilities. In more preferred embodiments, the rules engine steps are taken by computer devices operating as a service for retail vendors.

Step 610 contemplates providing access to a product database. The products database preferable stores product information relating to many different products across brand classifications. The product information can be stored as individual elements or bound to product objects representing actual real world products and having product attributes associated with the real world product attributes. The system can include a broad spectrum of product attributes including product inventor, product packaging parameters (e.g., color, font, etc.), recommend uses, manufacturing, distribution, shelf life, or any other attribute. One should appreciate that a single product can be represented by hundreds, thousands, or even tens of thousands of attributes.

Step 620 includes providing access to a rules engine, which preferably communicatively couples with the product database. The rules engine is preferably configured to analyze product information from the product database and determine if relationships might exist among products based on non-transaction correlations.

Step 630 includes the rules engine discovering one or more universal relationships based on the non-transactional correlations. The rules engine applies one or techniques of comparing products relative to each other when the products are correlated via an event other than a transaction. For example, two products might be related to each other because they were both referenced in a news story, appear in photograph together, or via other correlation. Preferably the products span across different brand classifications. Example brand classifications include genre, product type, media type, supply chains, celebrity, vendor, publisher, franchise, or other categories. When correlated in some fashion, either automatically identified correlation or user defined correlation, the rules engine seeks to fine a relationship among the attributes of the products. Perhaps the products have similar packaging colors, have opposite terminology on the packaging, or other relationship. The relationship can include one-to-one attribute relationships, one-to-many attribute relationships, or even many-to-many relationships.

In some embodiments, at step 633 the rules engine can infer a universal relationship among products across brand classifications. The rules engine can apply one or more techniques to infer the relationships include multi-variate analysis; inductive, abductive, deductive reasoning; neural networks; genetic algorithms, or other techniques. When a relationship is discovered, the rules engine can further validate the relationship at step 635. A relationship can be validated by establishing a relationship based on a portion of the data set in the product database, then comparing the relationship to a second portion, preferably a non-overlapping portion, to see if the relationship still holds. Validation of the relationship aids in establishing a certainty with which the relationship holds.

Step 640 includes the rules engine creating a cross-brand rules-set that configures a recommendation engine to generate cross brand recommendations. One should note that the created rules-set include instructions that guide the recommendation engine through querying the product database to select products to be recommended. The rules-sets can include weighting factors for selecting products to recommend, randomization rules for selecting products, placement of recommendations on an interface, or other rules. One should further note that a rules-set, even when based on the same data, can be different from one recommendation engine to another based on recommendation engine characteristics. When the rules-set is ready, it can be sent to the target recommendation engine. In some embodiments, the rules-set comprises a serialized stream of instructions, possibly based on XML.

When a rules-set is created, the rules-set can include a weighting factor indicative of how closely recommended products should be to other products with respect to their relationships. The weighting factor should be close, but not too close. If the recommendation is too close, a consumer might likely feel the product is too similar to another product with which they are familiar. One aspect of the inventive subject is to aid consumers in discovering new products. In some embodiments, the weighting factor for selecting products in other brand classifications fall within a weighting range derived by the rules engine. For example, when normalized to a number between 0 and 1, 0 indicating exactly the same and 1 being completely different, the range should at least have a low end greater than zero. An example range might be between 0.2 and 0.8 on the normalized scale. Naturally, any scale can be used. Thus, the recommendation engine could recommend a cross-brand product having a 20% (0.2) similarity based on the discovered relationships.

Step 650 includes the rules engine configuring a recommendation engine with the rules-set. As referenced earlier, in one embodiment of the inventive subject matter the rules engine operates as a service to a subscribing retailer or vendor. The recommendation engine might be owned or operated by the subscriber. The rules engine transmits the rules-set over a network, the Internet for example, to the recommendation engine as contemplated by step 655. In more preferred embodiments, the rules-set comprises a serialized XML-based file that can be transmitted via one or more standard protocols (e.g., HTTP, FTP, SSL, SMTP, etc.) over the Internet or other network. In some embodiments, the rules-set can be transmitted through other networks possibly including cell network, WiGIG, UWB, or other types of networks.

At step 660, the actions taken are more closely related to a recommendation engine possible operating as a kiosk or other type of interactive system located at a retail store. Still, one should keep in mind that the rules engine and recommendation engine could be the same physical hardware. In a preferred embodiment, the two engines are separate devices.

Step 660 includes the recommendation engine translating the rules-set into a local product database query. The recommendation engine uses local information including product parameters, consumer parameters, vendor parameters, retailer parameters, or information to populate variables in the rules-set as contemplated by step 665. This step can be considered customizing the query structures to the local site, consumer, or other entity. As the recommendation engine creates one or more queries by translating or customizing the rules-set, the queries can be submitted to a local product database to search for products satisfying the rules-set's requirements. Of particular note, the queries seek cross brand products with respect to a first brand classification, possibly determined by an initial consumer product request. The cross brand products are from a different brand classification that fall within the bounds of the discovered relationships or weighting factors. The local product database returns the cross brand products to the recommendation engine.

At step 670 the recommendation engine selects returned products as recommended products. The selection of products can be governed by the rules-set, which can include various rules for selecting the products as a recommendation. For example, a selected product might be selected at random according to a weighting. Other rules can include selecting a top number of products to be recommended according to a display size, paid placement, or other factors. Yet more rules could include exclusion rules possibly based on consumer preferences or even allergies.

Step 680 includes the recommendation engine configuring an output device to present selected recommended products. In the use-case of an interactive kiosk, the output device includes a display that presents the recommended products according to the rules-sets. In some embodiments, the cross-branded recommended products can be printed out as a shopping list including instructions on where each item is located within the store. Still, further the cross-branded recommended products can be downloaded in electronic form from the kiosk to a consumer's cell phone. For example, the kiosk can exchange data with the cell phone via a Blue Tooth or other type of communication connection.

The disclosed techniques allow users to discover new products outside the boundaries defined in terms of their own product interactions. Rather, the disclosed techniques seek universal relationships among products (e.g., goods, services, etc.) across brand classifications. For example, a consumer could receive a recommended type of dish soap based on a distribution channel of electronic devices near the consumer.

The universal relationships can further be analyzed with respect to one or more facets of the relationship data. Although universal relationships are discovered based on non-transaction correlations, transaction information can be used to classify the universal relations according to demographics, population profiles, geo-location, shopping patterns, or other classes. Further, transaction correlations can also be used to aid in a form of validation of a universal relationship.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A recommendation system, the system comprising:
a product database storing product information relating to products across brand classifications, the product information including product attributes associated with the products; and
a rules engine communicatively coupled with the product database and configured to:
discover universal relationships based on non-transaction correlations among the product attributes of products spanning across brand classifications;
create a cross-brand rules-set that configures a recommendation engine to generate product recommendations in a first brand classification based on products in a second different brand classification based on at least some of universal relationships; and
configure the recommendation engine to operate according to the rules-set.

2. The system of claim 1, wherein the rules engine is further configured create the cross-brand rules-set as a serialized instruction set.

3. The system of claim 1, wherein the rules engine is further configured to discover weighting factors relating the first and the second brand classifications based on the universal relationships.

4. The system of claim 3, wherein the rules engine is further configured to create the cross-brand rules-set based on the weighting factors.

5. The system of claim 3, wherein at least one of the weighting factors is a range within a weighting range.

6. The system of claim 5, wherein the weighting range comprises a normalized low end greater than zero.

7. The system of claim 1, wherein the rules engine is further configured to create the cross-brand rules-set based on randomized product recommendation rules.

8. The system of claim 1, wherein the first and second brand classifications include at least two different ones of the following classifications: genre, product type, media type, supply chains, celebrity, vendor, publisher, and franchise.

9. The system of claim 1, further comprising a kiosk configured as the recommendation engine.

10. The system of claim 1, further comprising the recommendation engine wherein the recommendation engine is configured to couple with a local product database local to the recommendation engine.

11. The system of claim 10, wherein the cross-brand rules-set configures the recommendation engine to construct product queries according to the rules-set and targeting the local product database.

12. The system of claim 10, wherein the cross-brand rules-set configures the recommendation engine to select products as recommended products from a result set obtained from the local product database.

13. The system of claim 10, wherein the cross-brand rules-set comprises instructions having consumer variables.

14. The system of claim 13, wherein the recommendation engine is configured to populate the consumer variables a function of consumer information.

15. The system of claim 10, wherein the cross-brand rules-set comprises instructions having product variables.

16. The system of claim 15, wherein the recommendation engine is configured to populate the product variables brand parameters a function of product information in the local product database.
